(19) United States
(12) Patent Application Publication
(10) Pub. No.: US 2022/0312733 A1
(43) Pub. Date: Oct. 6, 2022

(54) Pet Wearable Extending Bands

(71) Applicant: Pet Parents LLC, Ankeny, IA (US)

(72) Inventor: Blake Anderson, Ankeny, IA (US)

(21) Appl. No.: 17/657,410

(22) Filed: Mar. 31, 2022

Related U.S. Application Data
(60) Provisional application No. 63/168,596, filed on Mar. 31, 2021.

(51) Int. Cl. A01K 13/00; A44B 13/00; A01K 23/00

(52) U.S. Cl. CPC A01K 13/006; A44B 13/0052; A01K 23/00

(57) ABSTRACT

An extender for securing an article around a pet, the extender including: a first fastener portion located proximate a first end of the extender, the first fastener portion located on a first side of the extender; and a second fastener portion located proximate a second end of the extender, the second fastener portion located on a second side of the extender. The first fastener portion is shaped to engage a first fastener of the article and the second fastener portion is shaped to engage a second fastener of the article such that a length of the article is extended by a length of the extender between the first fastener portion and the second fastener portion.

### CROSS-REFERENCE TO RELATED APPLICATION

This application claims priority to and is a non-provisional of U.S. Patent Application Ser. No. 63/168,596 for “Pet Wearable Extending Bands” filed on Mar. 31, 2021, the contents of which are incorporated herein by reference in its entirety.

### FIELD

This disclosure relates to the field of pet products. More particularly, this disclosure relates to an extension for securing a pet product, such as a pet band, diaper, clothing or other pet products, around a pet.

### BACKGROUND

Various pet products exist that are configured to be worn by a pet. For example, products such as pet diapers or belly bands are adapted to be worn by a pet. These products may be secured around the pet such as by using a fastener, such as a hook and loop fastener. Although wearable pet products may be adjustable, pets may vary in size and there may be limits as to the range of adjustability of the pet products.

For example, a larger breed animal, such as a large dog, may require that a diaper or belly band be substantially larger in size compared to a similar product for a smaller breed animal, such as a small dog. Although some adjustability may be possible, there are limits to the adjustability of certain pet products such that a product that may be able to fit a smaller breed dog may not be able to accommodate a larger breed dog. Although various sizes may be created, manufacturing and selling different sizes of products is costly and it may not be possible to create sizes of products that fit all sizes of pets because every pet has a body that may differ in shape.

What is needed, therefore, a pet band extension that allows a pet product to fit animals that may be in between sizes, need adjustment of the product, to help keep the product on the pet, and/or to aid in keeping the pet comfortable.

### SUMMARY

The above and other needs are met by a pet band extender for fitting an article to a pet. In one aspect, an extender for securing an article around a pet includes a first fastener portion located proximate a first end of the extender, the first fastener portion located on a first side of the extender; and a second fastener portion located proximate a second end of the extender, the second fastener portion located on a second side of the extender. The first fastener portion is shaped to engage a first fastener of the article and the second fastener portion is shaped to engage a second fastener of the article such that a length of the article is extended by a length of the extender between the first fastener portion and the second fastener portion.

The first fastener portion may be a hook portion of a hook and loop fastener, and the second fastener portion may be a loop portion of a hook and loop fastener. The first fastener portion and the second fastener portion may be one or more of snaps, buttons, and hooks.

The pet extender may further include a stretchable portion located between the first fastener portion and the second fastener portion. The stretchable portion may include an elastic material located proximate to a center of the extender.

The pet extender may further include a border located around an edge of the extender. The pet extender may include a stretchable portion located along at least a lengthwise portion of the border.

One of the first fastener portion and the second fastener portion may be located proximate to opposing sides of the extender. The stretchable portion may include a pair of strips of elastic material located along a center of the extender.

In another aspect, an extender for securing an article around a pet includes: a first fastener portion located proximate a first end of the extender, the first fastener portion located on a first side of the extender and comprising a hook portion of a hook and loop fastener; and a second fastener portion located proximate a second end of the extender, the second fastener portion located on a second side of the extender and comprising a loop portion of a hook and loop fastener. The first fastener portion is shaped to engage a loop portion of a fastener of the article and the second fastener portion is shaped to engage a hook portion of a fastener of the article such that a length of the article is extended by a length of the extender between the first fastener portion and the second fastener portion.

The pet extender may further include a stretchable portion located between the first fastener portion and the second fastener portion. The stretchable portion may include an elastic material located proximate to a center of the extender. The stretchable portion may be located along at least a lengthwise portion of a border of the extender.

In yet another aspect, an extender for securing an article around a pet includes: a first fastener portion located proximate a first end of the extender, the first fastener portion located on a first side of the extender; a second fastener portion located proximate a second end of the extender, the second fastener portion located on a second side of the extender; and a stretchable portion located between the first fastener portion and the second fastener portion. The first fastener portion is shaped to engage a first fastener of the article and the second fastener portion is shaped to engage a second fastener of the article such that a length of the article is extended by a length of the extender between the first fastener portion and the second fastener portion.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a perspective view of a first side of an extender having a stretchable middle portion according to one embodiment of the present disclosure;

FIG. 2 shows a first side of an extender having a stretchable middle portion according to one embodiment of the present disclosure;

FIG. 3 shows a second side of an extender having a stretchable middle portion according to one embodiment of the present disclosure;

FIGS. 4 and 5 show side plan views of an extender according to one embodiment of the present disclosure;

FIGS. 6 and 7 show end plan view of an extender according to one embodiment of the present disclosure;

FIG. 8 shows a perspective view of a first side of an extender having a stretchable middle portion according to one embodiment of the present disclosure;

FIG. 9 shows a first side of an extender having a stretchable middle portion according to one embodiment of the present disclosure;

FIG. 10 shows a second side of an extender having a stretchable middle portion according to one embodiment of the present disclosure;

FIGS. 11 and 12 show side plan views of an extender according to one embodiment of the present disclosure;

FIGS. 13 and 14 show end plan view of an extender according to one embodiment of the present disclosure;

FIG. 15 shows a first side of an extender having a stretchable middle portion according to one embodiment of the present disclosure;

FIG. 16 shows a second side of an extender having a stretchable middle portion according to one embodiment of the present disclosure;

FIG. 17 shows a first side of an extender having a stretchable portion according to one embodiment of the present disclosure;

FIG. 18 shows a second side of an extender having a stretchable portion according to one embodiment of the present disclosure;

FIG. 19 shows a first side of an extender having a stretchable border according to one embodiment of the present disclosure;

FIG. 20 shows a second side of an extender having a stretchable portion according to one embodiment of the present disclosure;

FIG. 21 shows an embodiment of an extender located on a pet product according to one embodiment of the present disclosure; and

FIG. 22 shows an extender worn on a pet according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

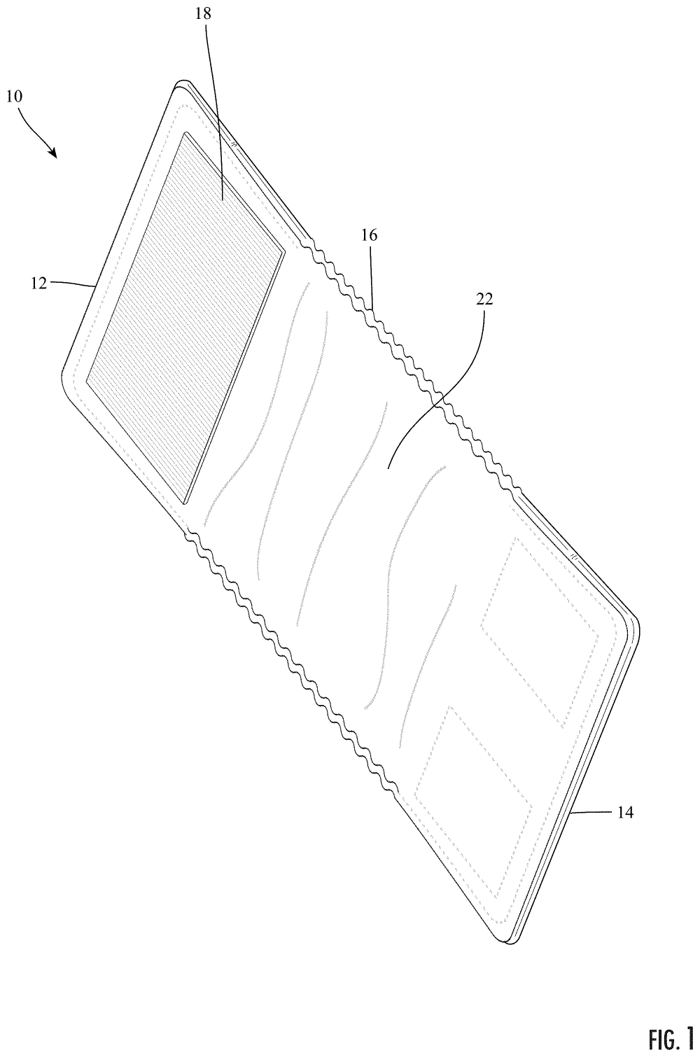

FIG. 1 shows an embodiment of an extender 10. The extender 10 is advantageously configured to be secured on a pet product worn by an animal, such as a dog diaper or belly band, to allow the pet product to fit the animal. In particular, embodiments of the extender 10 allow a product that may otherwise be too small or uncomfortable for a pet to be extended to fit around the pet without requiring significant modification to the pet product.

As shown in FIG. 1, the extender 10 includes a first end 12 and a second end 14 that is distal from the first end 12 of the extender 10. The extender 10 may be rectangular in shape, as shown in FIG. 1. However, it is also understood that the extender 10 may have various other suitable shapes for securing the extender 10 on a pet product as described in greater detail below. The extender 10 may include a border 16 extending around an outside edge of the extender 10. In one embodiment, the extender 10 is substantially formed of a fabric material. The border 16 may be formed of a stitched edge or boundary located around the extender 10.

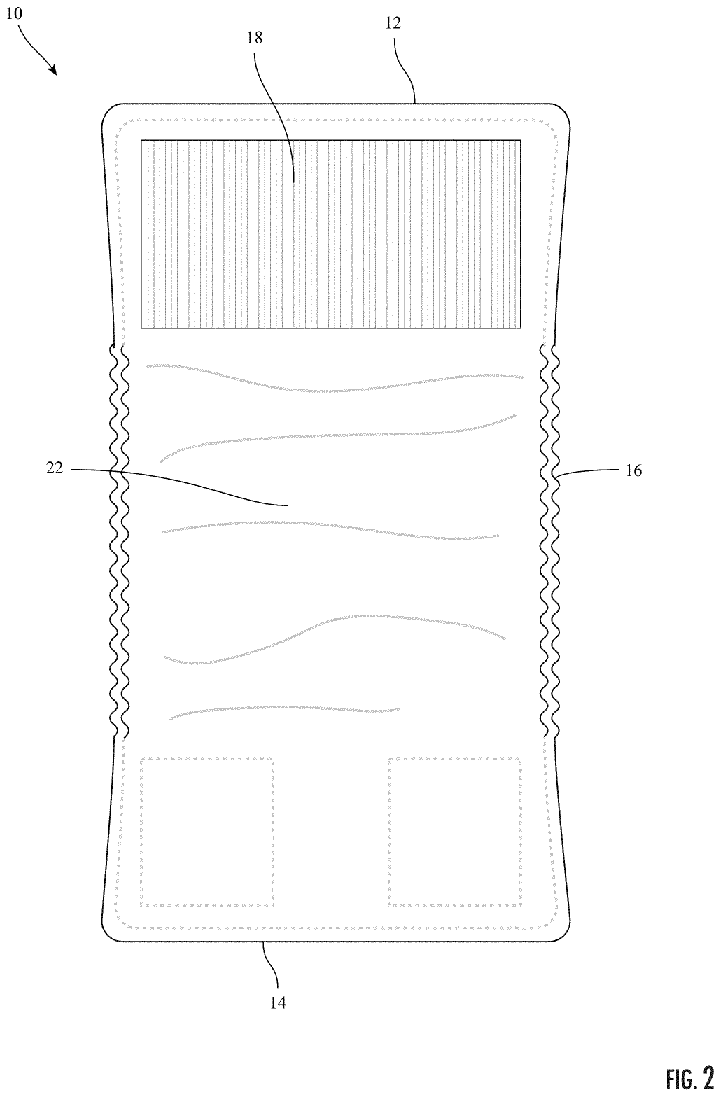

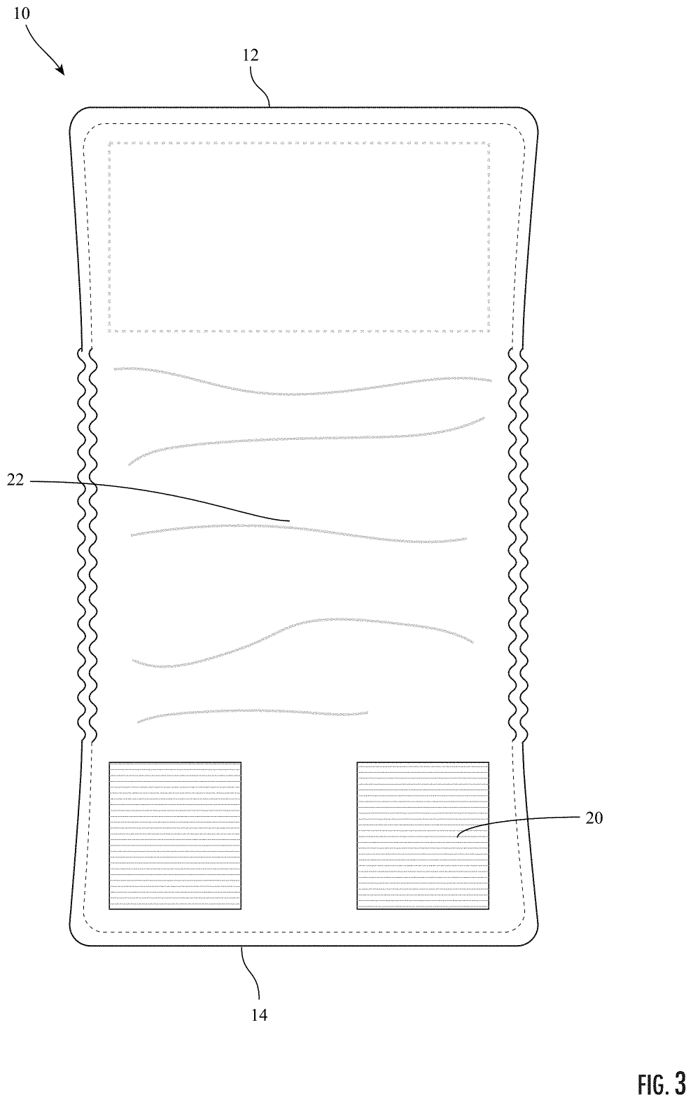

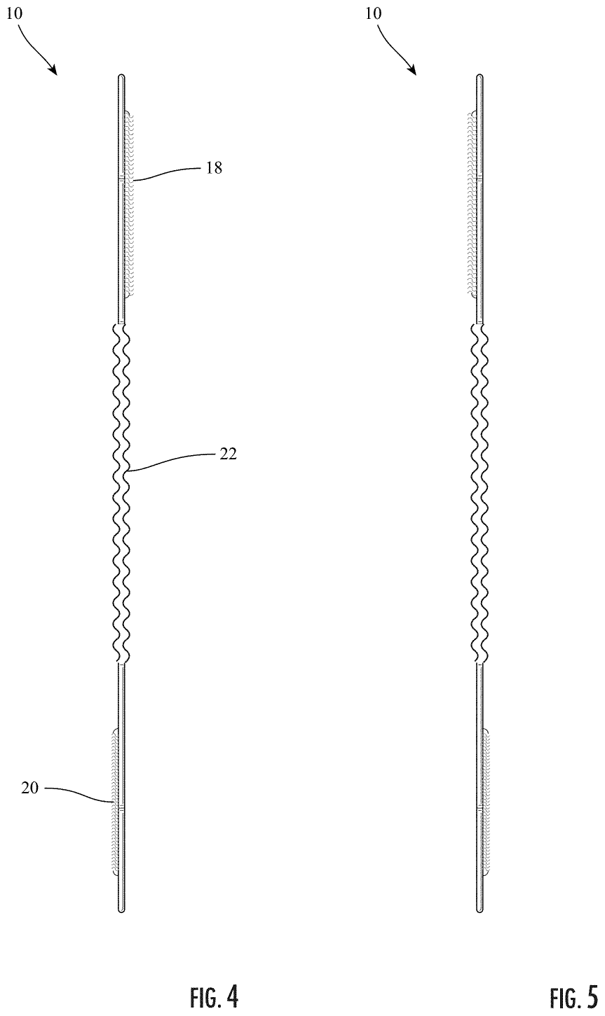

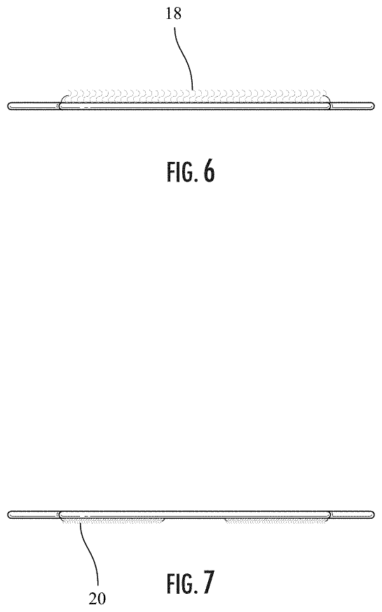

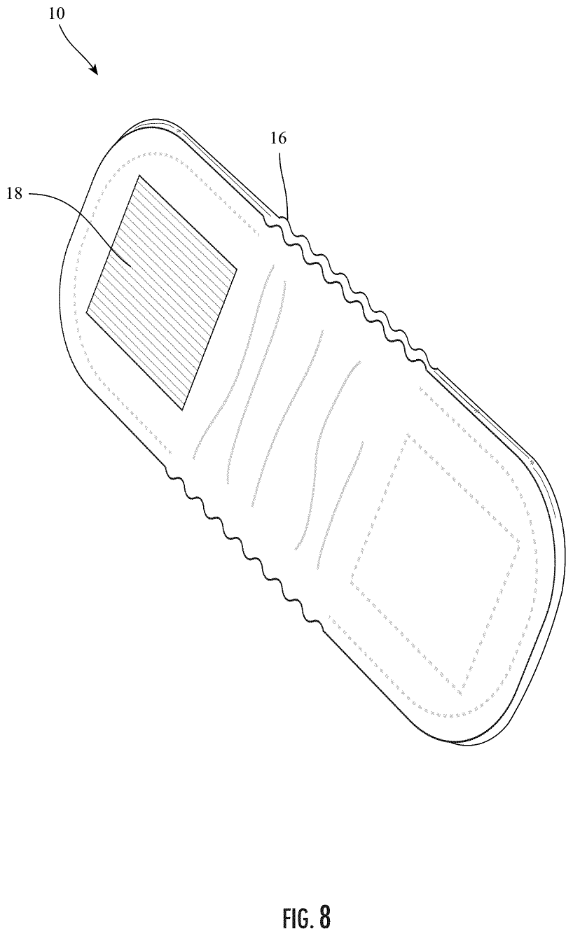

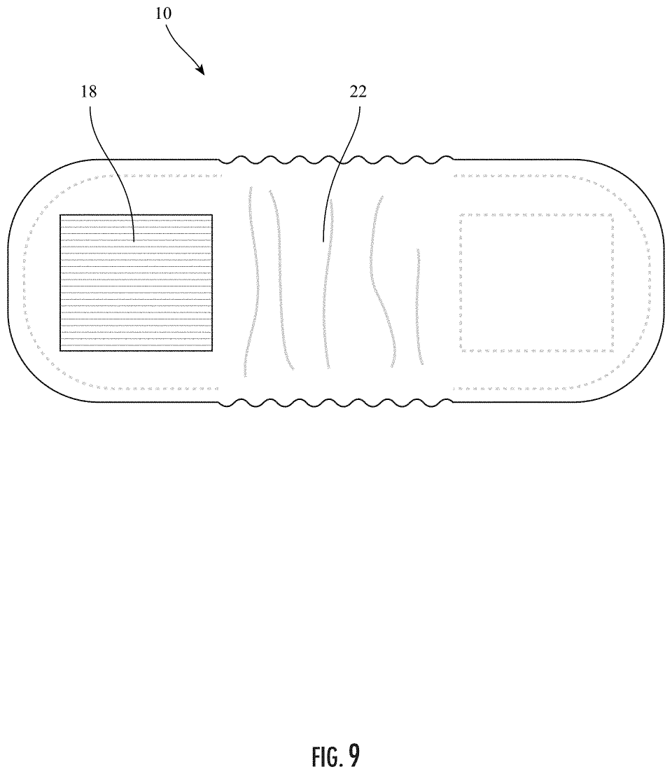

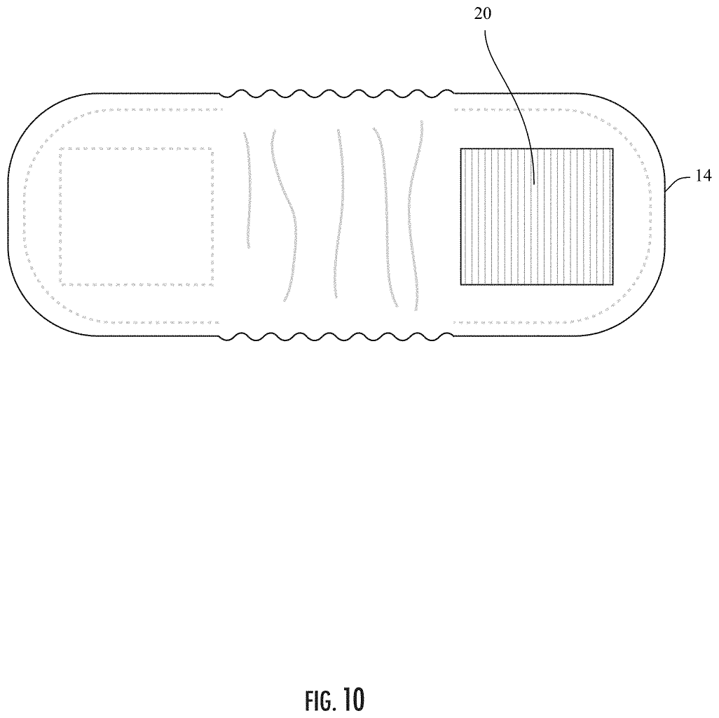

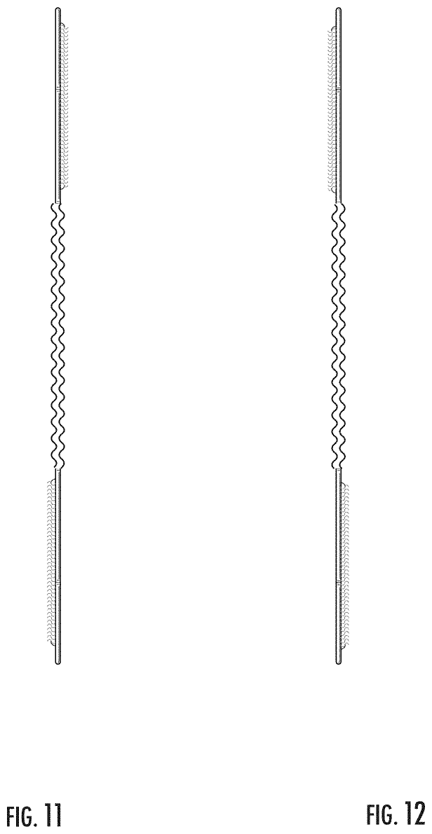

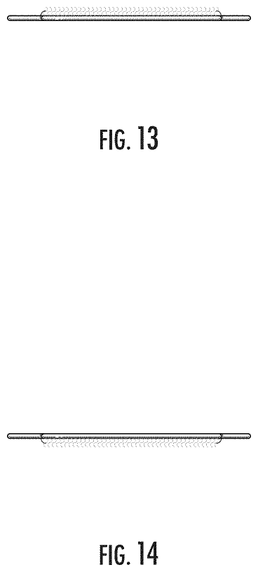

The extender 10 may further include a first fastener portion 18 located towards the first end 12 and a second fastener portion 20 located towards the second end 14. The first fastener portion 18 may be located on a first side of the extender 10 (FIG. 2) and the second fastener portion 20 may be located on a second side of the extender (FIG. 3). In one embodiment, the first fastener portion 18 is one of a hook or loop portion of a hook and loop fastener, while the second fastener portion 20 is the other of the hook or loop portion of a hook and loop fastener. Although reference is made herein to a hook and loop fastener, it is also understood that embodiments of the extender 10 may be formed having other various suitable fasteners, such as snaps, buttons, hooks, etc.

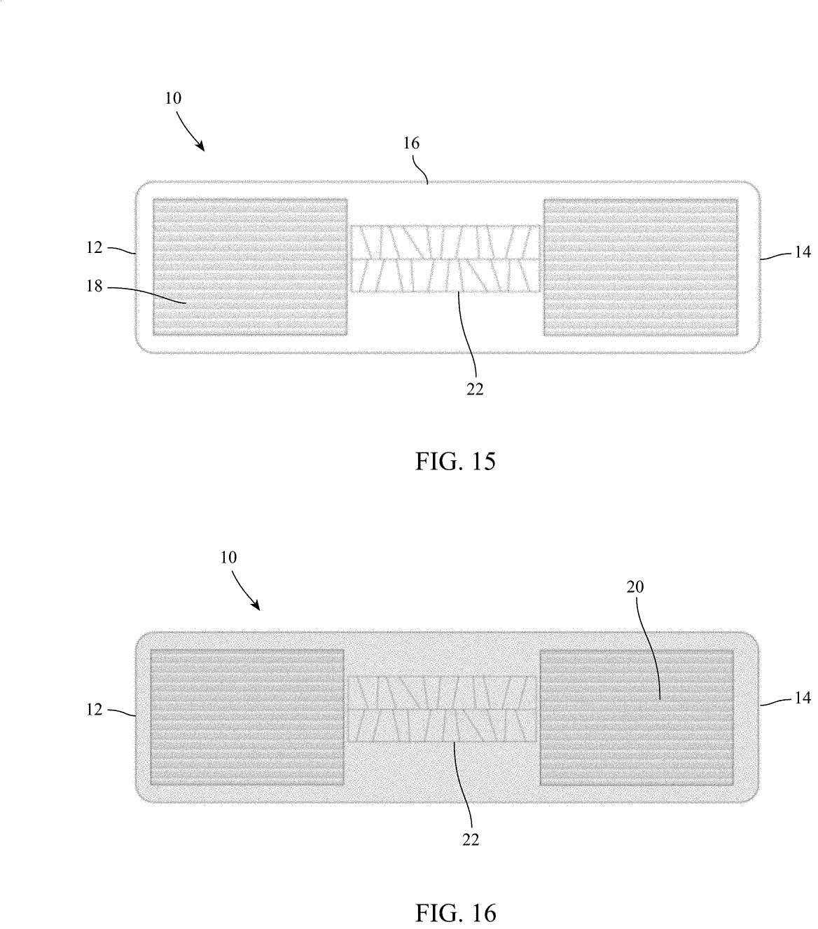

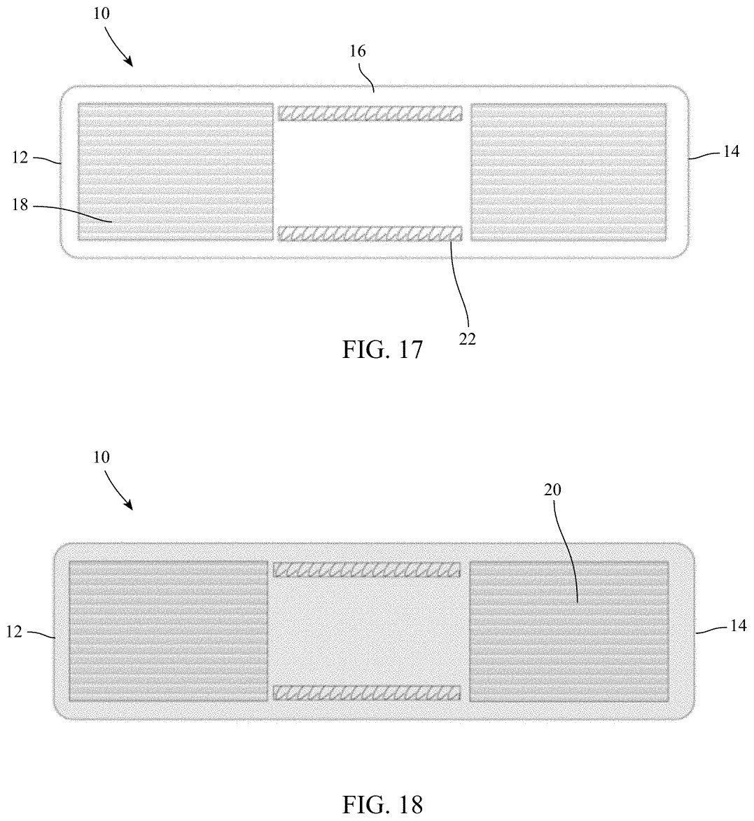

The extender 10 further includes a stretchable portion 22. In one embodiment, the stretchable portion 22 is located towards a center of the extender 10, as shown in FIG. 15 and FIG. 16. The stretchable portion 22 may be formed using an elastic material located on the extender 10. The stretchable portion 22 is formed such that a length of the extender 10 may be extended by pulling first end 12 and the second end 14. The stretchable portion 22 is configured such that the extender 10 is biased towards a contracted position such that when the first end 12 and the second end 14 are pulled away from each other, the stretchable portion 22 resists stretching of the extender 10. In the embodiment shown in FIGS. 1 and 2, the stretchable portion 22 may be formed such as by locating an elastic material at a center of the extender 10. For example, the stretchable portion 22 may be stitched within the extender 10 towards the center of the extender 10.

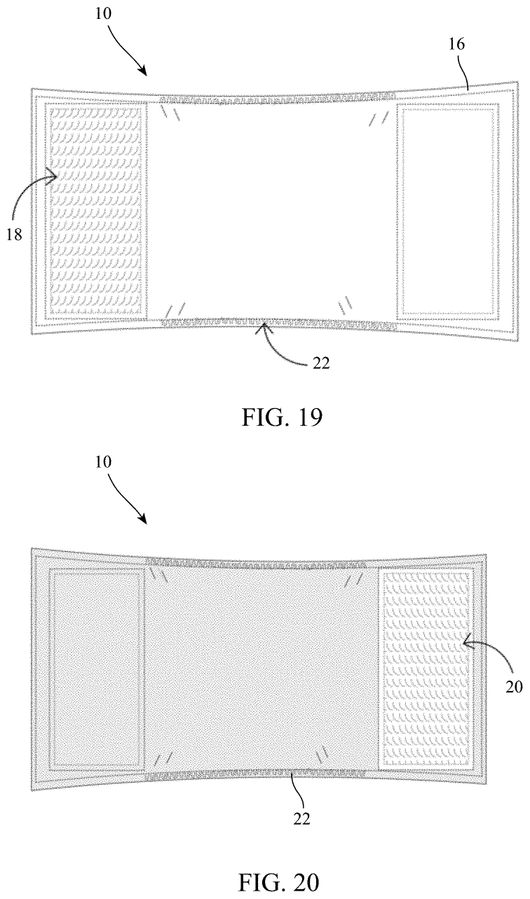

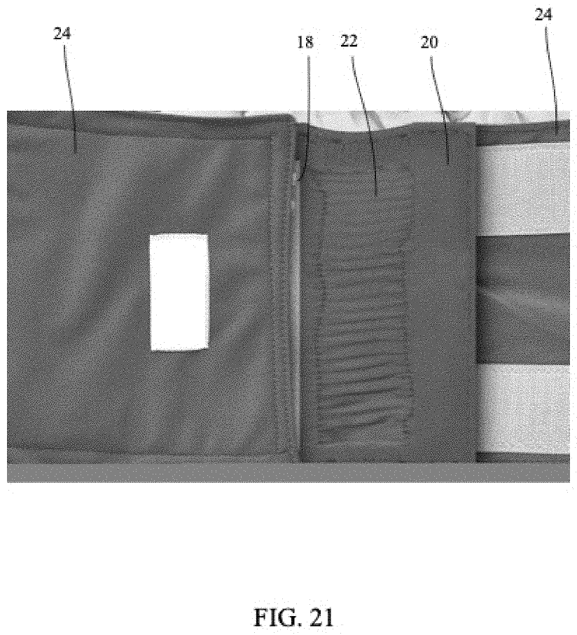

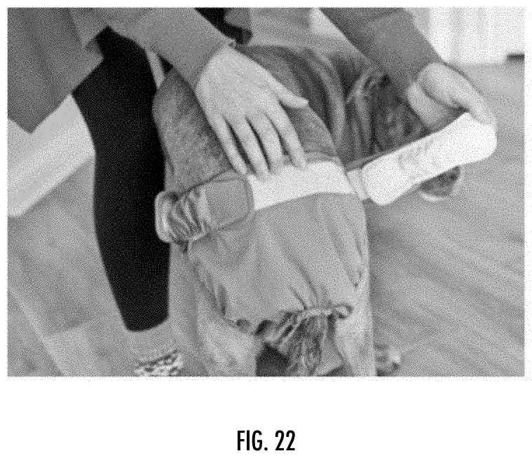

In another embodiment the stretchable portion 22 is formed on the border 16 of the extender, as shown in FIG. 19 and FIG. 20. For example, the stretchable portion 22 may be formed along portions of the border 16. The stretchable portion 22 may be formed on opposing sides of the border 16 of the extender 10, such as towards a center of the border 16 of the extender 10. When ends of the extender 10 are pulled, the stretchable portion 22 at the border 16 allows a length of the extender 10 to be increased. Further, the stretchable portion 22 at the border 16 is biased towards a contracted position such that when the extender 10 is pulled the stretchable portion 22 urges the extender 10 towards its original un-stretched shape. The stretchable portion 22 may be formed such as by forming at least a portion of the border 16 out of an elastic material.

The extender 10 allows a size of a pet product, such as a dog diaper or belly band, to be increased such that the pet product will fit or better fit on a pet. A pet product may include, for example, a belly band for a dog. The pet product may include a hook and loop fastener for securing the pet product around a pet. The extender 10 may be secured on the pet product between fastener portions of the pet product. For example, the first fastener portion 18 may be secured on a fastener portion of the pet product on a first end of the pet product, while the second fastener portion 20 may be secured on a fastener portion of the pet product on a second end of the pet product. The stretchable portion 22 may be located between ends of the pet product 24 such that a diameter of the pet product is expanded to fit around a pet and further such that a length of the extender 10 is stretchable between ends of the pet product.

The extender 10 advantageously allows an existing pet product to be adjusted to allow the pet product to fit animals that may be in between sizes, need adjustment of the product, to help keep the product on the pet, and/or to aid in keeping the pet comfortable. Further, the extender 10 allows the pet to comfortably wear the pet product by providing for an amount of stretch in the extender, thereby allowing movement of the pet without causing discomfort due to tightening of the product around the pet.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An extender for securing an article around a pet, the extender comprising:
a first fastener portion located proximate a first end of the extender, the first fastener portion located on a first side of the extender;
a second fastener portion located proximate a second end of the extender, the second fastener portion located on a second side of the extender;
wherein the first fastener portion is shaped to engage a first fastener of the article and the second fastener portion is shaped to engage a second fastener of the article such that a length of the article is extended by a length of the extender between the first fastener portion and the second fastener portion.

2. The extender of claim 1, wherein the first fastener portion comprises a hook portion of a hook and loop fastener, and wherein the second fastener portion comprises a loop portion of a hook and loop fastener.

3. The extender of claim 1, wherein the first fastener portion and the second fastener portion are selected from the group consisting of snaps, buttons, and hooks.

4. The extender of claim 1, further comprising a stretchable portion located between the first fastener portion and the second fastener portion.

5. The extender of claim 4, the stretchable portion comprising an elastic material located proximate to a center of the extender.

6. The extender of claim 1, further comprising a border located around an edge of the extender.

7. The extender of claim 6, further comprising a stretchable portion located along at least a lengthwise portion of the border.

8. The extender of claim 1, wherein one of the first fastener portion and the second fastener portion is located proximate to opposing sides of the extender.

9. The extender of claim 4, the stretchable portion comprising a pair of strips of elastic material located along a center of the extender.

10. An extender for securing an article around a pet, the extender comprising:
a first fastener portion located proximate a first end of the extender, the first fastener portion located on a first side of the extender and comprising a hook portion of a hook and loop fastener;
a second fastener portion located proximate a second end of the extender, the second fastener portion located on a second side of the extender and comprising a loop portion of a hook and loop fastener;
wherein the first fastener portion is shaped to engage a loop portion of a fastener of the article and the second fastener portion is shaped to engage a hook portion of a fastener of the article such that a length of the article is extended by a length of the extender between the first fastener portion and the second fastener portion.

11. The extender of claim 10, further comprising a stretchable portion located between the first fastener portion and the second fastener portion.

12. The extender of claim 11, the stretchable portion comprising an elastic material located proximate to a center of the extender.

13. The extender of claim 11, the stretchable portion located along at least a lengthwise portion of a border of the extender.

14. An extender for securing an article around a pet, the extender comprising:
a first fastener portion located proximate a first end of the extender, the first fastener portion located on a first side of the extender;
a second fastener portion located proximate a second end of the extender, the second fastener portion located on a second side of the extender;
a stretchable portion located between the first fastener portion and the second fastener portion;
wherein the first fastener portion is shaped to engage a first fastener of the article and the second fastener portion is shaped to engage a second fastener of the article such that a length of the article is extended by a length of the extender between the first fastener portion and the second fastener portion.
